(19) United States
(12) Patent Application Publication
(10) Pub. No.: US 2025/0077868 A1
(43) Pub. Date: Mar. 6, 2025

(54) PRUNING FOR NEURAL NETWORK MODELS

(71) Applicant: ORACLE INTERNATIONAL CORPORATION, Redwood Shores, CA (US)

(72) Inventors: Baopu LI, Santa Clara, CA (US); Tao SHENG, Bellevue, WA (US); Jun QIAN, Newcastle, WA (US)

(21) Appl. No.: 18/239,198

(22) Filed: Aug. 29, 2023

(51) Int. Cl. G06N 3/082; G06N 3/0464

(52) U.S. Cl. CPC G06N 3/082; G06N 3/0464

(57) ABSTRACT

Systems, methods, and other embodiments associated with contribution metric-based pruning of a neural network are described. In one embodiment, an example method includes accessing a trained neural network that has a plurality of channels. The neural network is to be evaluated for pruning of the channels. The example method may also include determining contribution metrics for the channels by measuring changes in error of the convolutional neural network with individual channels removed in turn. The contribution metrics are determined based at least in part on higher order analysis of the changes. And, the example method may also include pruning out of the convolutional neural network a set of the channels for which the contribution metrics do not satisfy a threshold.

### BACKGROUND

Convolutional neural network (CNN) models have found wide applications in many different areas such as autonomous driving, robotics, optical character recognition, and so on because of impressive performance compared to other machine learning based models. However, the high computational complexities as well as the large model size for CNN models tend to hinder usage of CNN models. This is especially true for resource-constrained devices such as cellular or mobile phones, edge devices, Internet of things (IoT)-connected devices, or other devices with limited processing and/or storage capacities.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be implemented as multiple elements or that multiple elements may be implemented as one element. In some embodiments, an element shown as an internal component of another element may be implemented as an external component and vice versa. Furthermore, elements may not be drawn to scale.

FIG. 1 illustrates one embodiment of an importance-based pruning system associated with pruning of neural network models.

FIG. 2 illustrates one embodiment of an importance-based pruning method associated with pruning of neural network models.

FIG. 3 illustrates another embodiment of an importance-based pruning method 200 associated with pruning of neural network models.

FIG. 4 illustrates an embodiment of a computing system configured with the example systems and/or methods disclosed.

### DETAILED DESCRIPTION

Systems and methods are described herein that provide for improved pruning of neural network models. In one embodiment, an importance-based pruning system automatically identifies and prunes away channels or filters of a convolutional neural network (CNN) that are least important to the predictive accuracy of the CNN. In this way, the importance-based pruning system compresses the CNN in a way that reduces computational burden while maintaining accuracy.

In one embodiment, the importance-based pruning systems, methods, and other embodiments described herein improve the technology of neural networks in a variety of ways. In one embodiment, importance-based pruning at the channel/filter level as described herein is markedly more effective at making a CNN hardware-friendly than unstructured pruning, which prunes out individual connections between neurons, resulting in sparse weight matrices that do little to reduce the computing and memory demands of the pruned CNN. Also, in one embodiment, pruning of entire channels based on assessed importance of the channels as described herein allows pruning to meet a pre-specified compression ratio for the CNN. In one embodiment, importance-based pruning as described herein considers higher-order information about channel activation that is disregarded by other pruning methods, enabling a more accurate assessment of the importance of a particular channel in the neural network.

In one embodiment, an importance-based pruning system examines a trained convolutional neural network to establish how much individual channels in the trained CNN contribute towards the output of the trained CNN. The measure of how much a channel contributes to the output is referred to herein as an “importance” or “contribution” of the channel. The importance-based pruning system determines metrics that quantify contributions or importances of channels in the trained CNN based on how much removing the channel effects the accuracy of the trained CNN. Where a channel contributes more to the output accuracy of the trained CNN (e.g., has a higher contribution metric or importance metric), then the channel is more important to the output. Thus, the importance of the channel is higher, and would have a higher contribution/importance metric. The least important channels or channels that contribute the least (based on the contribution metric or importance metric for the channel) are then removed, thereby pruning the trained CNN based on the importance or contribution of the channels. In one embodiment, the importance-based pruning system considers higher-order information about a channel in addition to first order, gradient-based information in order to arrive at a more accurate assessment of the importance or contribution of the channel.

### Definitions

As used herein, the term “prune” or “pruning” refers to deleting parameters (such as channels) or otherwise removing the influence of the parameters from an existing neural network. One goal of pruning is to increase the efficiency of the neural network in terms of size and compute time. Pruning may come at the expense of accuracy when parameters contribute to the estimates output by the neural network.

As used herein, the term “channel” refers to a feature mapping that represents a particular type of the input or intermediate data in a neural network. In other words, a channel is a specific feature or characteristic of the data that is being considered by the neural network. For example, in the context of image recognition, channels of the input layer of the neural network may include intensities of color, such as red, green, and blue channels. Channels at an intermediate (or hidden) layer of the network represent results of particular convolutional filters at the intermediate layer. For example, in the context of image recognition, channels at intermediate layers may represent edges, corners, textures, curves, or other meaningful combinations of features from previous layers of the neural network. As layers progress, the channels in the layer represent increasingly compound features. In one embodiment, each of the channels may be stored as a separate channel in a feature map (the output) of one layer in the neural network.

As used herein, the terms “importance”, “importance metric”, and “contribution metric” all refer to a numerical representation of an extent that a channel (or the underlying filter) contributes to production of an estimate by (i.e., contributes to predictive accuracy of) the model. Various example measures for importance are described in further detail elsewhere herein.

As used herein, the term “estimate” refers to an output generated by a neural network from one set of inputs to the neural network.

As used herein, the term “resource-constrained device” refers to a computing device for which executing the neural network in an unpruned state (i) adversely affects operations of the device or (ii) exceeds compute resources allotted or available for executing the neural network.

### —Example Importance-Based Pruning System—

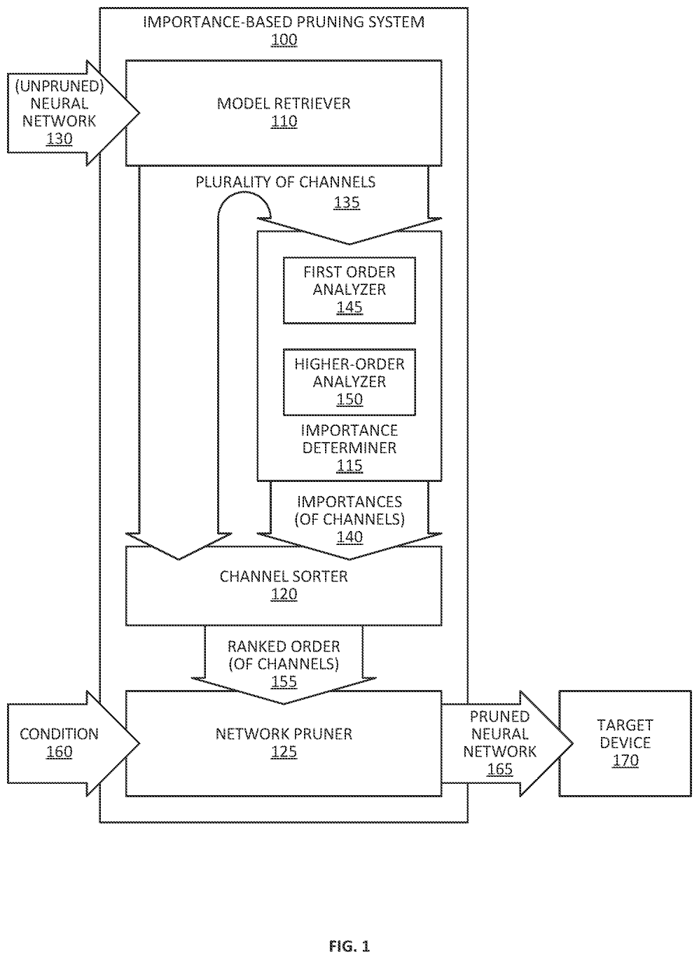

FIG. 1 illustrates one embodiment of an importance-based pruning system 100 associated with pruning of neural network models. Importance-based pruning system 100 includes components for removing from a neural network channels that contribute minimally to accurate outputs of the neural network. In one embodiment, the components of importance-based pruning system 100 include a model retriever 110, an importance determiner 115, a channel sorter 120, and a network pruner 125.

In one embodiment, model retriever 110 is configured to access or retrieve a neural network 130 such as a trained convolutional neural network. The neural network 130 has a plurality of channels 135. The neural network 130 is to be evaluated for pruning of the plurality of channels 135. The neural network 130 has been trained to generate an estimate or other output based on the plurality of channels 135. The plurality of channels 135 are included in the neural network 130. In one embodiment, model retriever 110 is configured to identify the plurality of channels 135 in the neural network 130, for example, by parsing a data structure (such as a matrix) for the neural network 130 to detect the plurality of channels 135.

In one embodiment, importance determiner 115 is configured to determine contribution metrics (importances) 140 for the plurality of channels 135 by measuring changes or fluctuations in error of the neural network 130 with individual channels removed in turn. In one embodiment, the contribution metrics 140 are determined based at least in part on a first order analysis by first order analyzer 145 of the changes (for example as discussed below with reference to gradient-based importance). In one embodiment, the contribution metrics 140 are determined based at least in part on a higher-order analysis by higher-order analyzer 150 of the changes (for example as discussed below with reference to information-based importance). In one embodiment, importance determiner 115 determines the contribution metrics in two phases. For example, importance determiner 115 is configured to, in a first phase, measure changes in error of the estimate due to the removal of individual channels from the neural network. And, importance determiner 115 is further configured to, in a second phase, determine extents of contribution towards the accuracy of the estimate for the individual channels based on the measured changes in error. The extent to which an individual channel contributes towards accuracy of the estimate produced as output by the neural network is a measure of the importance of the individual channel in the neural network.

In one embodiment, channel sorter 120 is configured to rank or sort the plurality of channels 135 by the respective contribution metrics of the channels, producing a ranked order 155 of the channels. More particularly, channel sorter 120 is configured to sort or place the plurality of channels 135 in an ascending (or descending) order of the respective contribution metrics of the channels. In this way, channel sorter is configured to place the channels of the neural network in a ranked order 155 of how much a given channel contributes to the accuracy of output produced by neural network 130.

In one embodiment, network pruner 125 is configured to prune out of the neural network 130 those of the channels that are least ranked in terms of contribution metric (or importance). In one embodiment, network pruner 125 is configured to continue the pruning until a condition 160 is satisfied. Condition 160 is a condition for concluding the pruning process. In one embodiment, the condition 160 may relate to performance of the neural network 130 as pruned (pruned neural network 165). For example, the condition 160 may be a compression (pruning) ratio indicating how much the pruned neural network 165 is reduced in size (from initial neural network 130). Or, for example, the condition 160 may be a resource constraint such as size of the pruned neural network 165 in memory or compute time taken to execute the pruned neural network 165. In one embodiment, network pruner 125 is configured to prune out of the neural network 130 a set of channels for which the contribution metrics do not satisfy a threshold for importance of channels. In this example, the condition 160 may be that the contribution metrics for the channels satisfy a minimum threshold level of importance. In one embodiment, network pruner 125 is configured to reconfigure the neural network 130 to remove a set of individual channels that contribute least towards the accuracy of the estimate that is produced by the neural network 130, thereby producing a pruned neural network 165. The pruned neural network 165 may then be deployed for operation in a target device 170, such as a resource-constrained device.

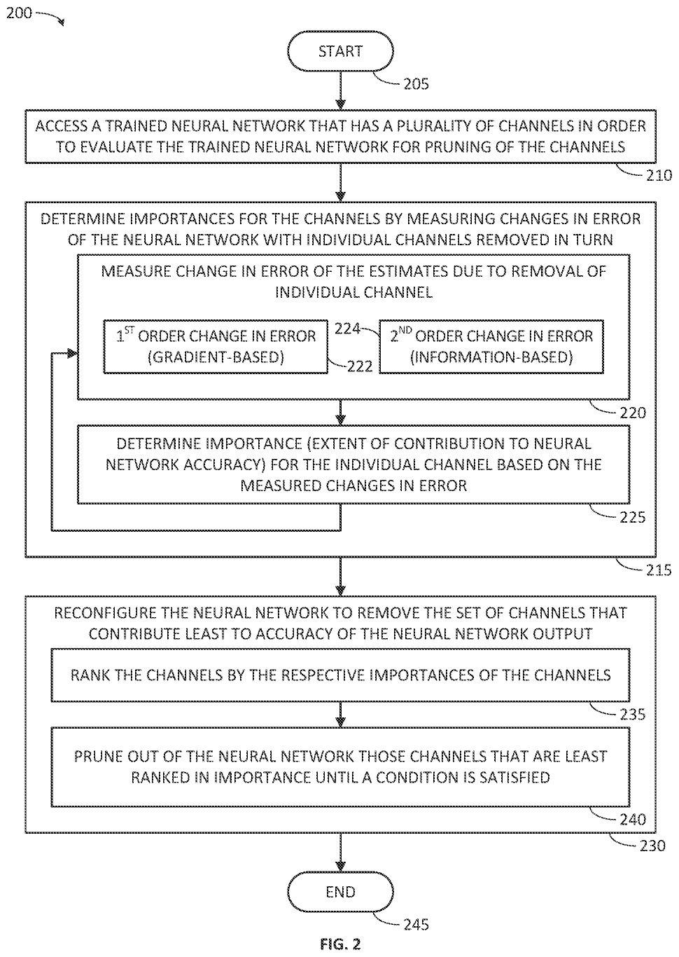

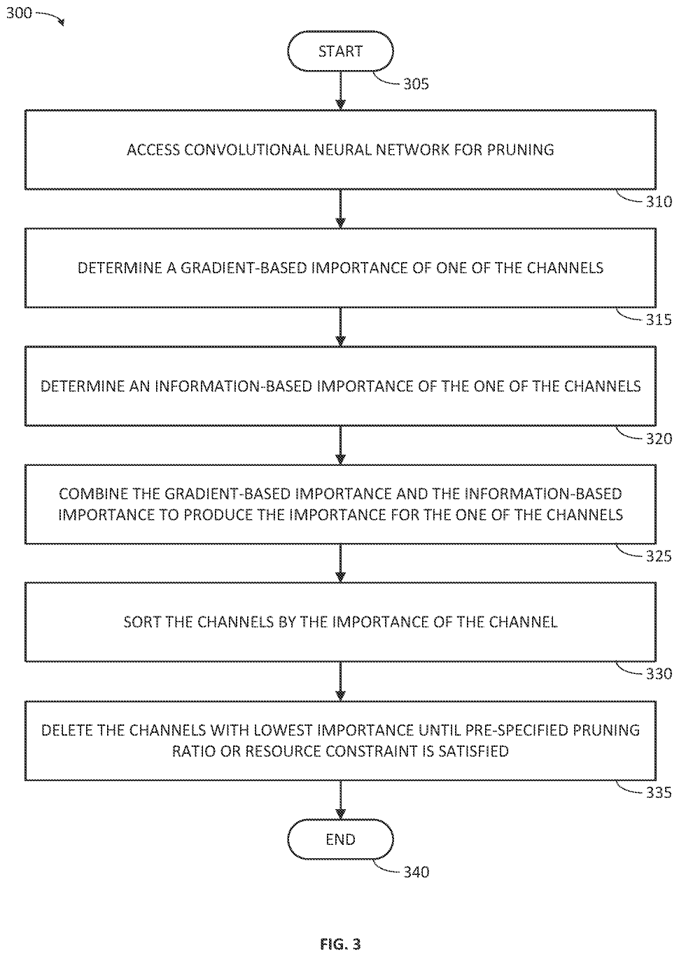

Further details regarding importance-based pruning system 100 are presented herein. In one embodiment, the operation of importance-based pruning system 100 will be described with reference to example importance-based pruning methods 200 and 300 shown in FIGS. 2 and 3.

### —Example Importance-Based Pruning Method—

FIG. 2 illustrates one embodiment of an importance-based pruning method 200 associated with pruning of neural network models. In one embodiment, importance-based pruning method 200 analyzes a trained convolutional neural network to determine which channels—that is, filter outputs—may be pruned away. The least important channels—channels that have the least contribution metric—are identified by an analysis of the cost function that was used to train the neural network in the first place. The contribution metric is a measure or quantification of an effect or impact of the channel on the overall accuracy of the trained neural network. In one embodiment, the analysis examines both first and second order derivatives of the cost function to determine the overall importance (contribution metric) of a channel with reference to the information gained from both the gradient of the cost function (first order analysis) and the concavity of the cost function (second order analysis). The least important channels are then removed from the trained neural network. In one embodiment, the resulting pruned neural network is more compact in representation than the original neural network and uses fewer processor operations to generate outputs from inputs than the original neural network, while suffering little loss in accuracy in comparison to the original neural network.

In one embodiment, importance-based pruning method 200 initiates at START block 205 in response to an importance-based pruning system (such as importance-based pruning system 100) determining one or more of (i) that a importance-based pruning system has been instructed to prune a neural network; (ii) that an instruction to perform importance-based pruning method 200 on a neural network has been received (iii) a user or administrator of a importance-based pruning system has initiated importance-based pruning method 200; (iv) it is currently a time at which importance-based pruning method 200 is scheduled to be run; or (v) that importance-based pruning method 200 should commence in response to occurrence of some other condition. In one embodiment, a computer system configured by computer-executable instructions to execute functions of importance-based pruning system 100 executes importance-based pruning method 200. Following initiation at start block 205, importance-based pruning 200 continues at block 210.

At block 210, importance-based pruning method 200 accesses a trained neural network that has a plurality of channels. The neural network is accessed or retrieved from storage in order to evaluate the trained neural network for pruning of the channels. The neural network has been trained to generate an estimate based on a plurality of channels within the neural network. In one embodiment, the steps of block 210 may be performed by model retriever 110.

In one embodiment, the trained neural network is represented as a data structure such as a directed acyclic graph in which the nodes represent an operation or function, and the edges represent the data flow between these functions. In one embodiment, the trained neural network is represented as a matrix with values defining the elements of the neural network. The neural network is organized in layers, including an input layer, one or more intermediate or “hidden” layers, and an output layer. In one embodiment, the neural network is a convolutional neural network, in which one or more of the intermediate layers are convolutional layers which apply filters to input data to detect patterns. In one embodiment, intermediate layers of a convolutional neural network include repeated pairs of batch normalization (BN) and rectified linear (ReLU) activation layers The learnable parameters of the neural network, such as the weights and biases applied to the nodes of each layer, may be stored as tensor data structures (e.g., multi-dimensional arrays).

Channels in the neural network are represented as dimensions in the tensors used to store input data and intermediate activations for the nodes in the layers of the neural network. In other words, the activations of the nodes in the network are also stored as tensor data structures, and the channels are represented by one of the dimensions in the tensor. The number of channels corresponds to the number of filters applied in the layer of the neural network. Thus, the number of channels may differ from layer to layer of the neural network depending on the number of filters applied in the layer. Pruning of a channel will therefore cut off or discard the output of a filter that corresponds to the channel. The effect of that filter is thus removed from consideration in subsequent layers of the neural network.

In one embodiment, the neural network has been trained to generate an estimate (output) based on a plurality of channels within the neural network. To train the neural network, a training vector of data sampled from a set of training data is fed forward through the neural network in a forward pass. Each layer of the neural network performs its respective operations, further transforming the inputs though the progressive intermediate layers until output is produced at the output layer. The output is compared with “actual” or “true” values for the output that are assigned to the training vector. The comparison is performed using a loss (or cost) function to calculate the loss between the output of the model. Then, the weights and biases of the model are updated in a backpropagation pass. Starting from the output layer, the gradient of the loss is computed with respect to the activations of the outputs. The gradients are computed for each channel separately. To account for the impact of each channel on the loss function, the gradients from the following layers subsequent to a current layer (towards output) are summed across channels to produce the gradients for the activations of the current layer. The gradients are backpropagated through the layers (from the output layer towards the input layer), updating the gradients at each layer by the chain rule. The weights and biases are then updated using an optimization algorithm (such a stochastic gradient descent) based on the gradients. The optimization algorithm determines the directions and magnitudes of the weight updates that will reduce the loss function. This forward-backpropagation cycle repeats using different selections of training vectors until the loss function is minimized (that is, until the loss function satisfies a threshold for minimization). Thus, the neural network as trained will generate (or infer) estimates. The estimates are based on a plurality of channels within the neural network.

In one embodiment, to access the trained neural network, importance based pruning method 200 accepts an input of a location in storage or memory of a data structure which represents or defines the trained neural network (such as a file path). Then importance-based pruning method 200 locates the data structure within the file system of the computing system. Once located, the importance-based pruning method 200 opens the data structure to enable read, write, or modify operations to be applied to the neural network represented by the data structure. At the conclusion of pruning, the data structure may be saved to finalize the pruning changes and then closed to release the pruned neural network for use by other features.

In one embodiment, importance based pruning method 200 parses the data structure of the neural network to detect individual channels and identify locations of the individual channels in the neural network. For example, the individual channels of the neural network are compiled into a list of channels in association with locations in the data structure of parameters that define the channels. For example, the list of channels may be a data structure such as a table with rows keyed by identifiers for the channels in the list. Information about a channel such as the location of the channel in the neural network, importance (such as gradient-based, information-based, and overall contribution metrics) of the channel are stored in a row keyed by an identifier for the channel. In this way, the plurality of channels in the neural network can be located and modified. The locations of the channels allow targeted removal of the channels from the neural network.

At block 215, importance-based pruning method 200 determines contribution metrics (or importances) for the channels by measuring changes in error of the convolutional neural network with individual channels removed in turn. The contribution metrics are determined based at least in part on first-order analysis of the changes and higher-order analysis (that is, at least second-order analysis) of the changes. The changes in the error of the estimate are thus measured due to removal of individual channels from the neural network. In one embodiment, the steps of block 215 may be performed by importance determiner 115.

In one embodiment, to remove the channels in turn, one channel at a time is removed from the neural network, the measurement of changes in error of the loss function is taken, and the channel replaced, proceeding through each of the channels. In other words, a channel is temporarily pruned out of the neural network, and then replaced after the effect of the removal on neural network accuracy is assessed. In this way, the effect on the loss function of individual channels may be assessed.

In one embodiment, a channel is removed by modifying the architecture of the neural network to remove the channel from the layer of the neural network that includes the channel. For example, the parameters (such as weights and biases) corresponding to the channel may be set to zero or deleted altogether. This deactivates the channel or turns the channel off. Further, connections to the prior and subsequent layers may be updated, if necessary, to accommodate the deactivation. In this way, the influence of the channel (and its corresponding filter) is removed from the neural network.

The parameter values for the channel may also be copied from the neural network and stored separately in memory for subsequent restoration or reactivation of the channel. The un-pruned configuration of the channel is thus retained during the evaluation of the changes in the loss function. Once the change in the loss function has been determined, the parameter values for the channel may be retrieved from temporary storage and written back into their respective former places in the neural network to reactivate the channel. The connections to the prior and subsequent layers may also be restored if they had been deleted.

While a channel is temporarily deleted, deactivated, or otherwise removed, the resulting changes in error of the output estimate may be determined from the change in the loss function. At block 220, importance-based pruning method 200 measures changes in error of the output estimate due to removal of individual channels of the plurality of channels from the neural network. In one embodiment, the change in error is measured both with respect to the first-order derivative of the loss function and the second-order (or other higher order) derivative of the loss function. In one embodiment, the loss function analyzed with respect to the first-order and second order derivatives is the loss function used to originally train the neural network.

In one embodiment, at block 222 importance-based pruning method 200 measures change in error of the estimate due to removal of individual channels using a first order (gradient-based) analysis. In one embodiment, additional detail regarding the first-order, gradient-based analysis of the change is discussed below under the heading “Gradient-Based Importance (First Order)”. In one embodiment, the steps of block 222 may be performed by first-order analyzer 145.

And, in one embodiment, at block 224 importance-based pruning method 200 also measures change in error of the estimate due to removal of individual channels using a second order (information-based) analysis. In one embodiment, additional detail regarding the higher-order, information-based analysis of the change is discussed below under the heading “Fisher Information-Based Importance”. In one embodiment, the steps of block 224 may be performed by higher-order analyzer 150.

At block 225, importance-based pruning method 200 determines importances—extents of contribution towards the accuracy of the estimate—for the individual channels based on the measured changes in error. In other words, importance-based pruning method 200 determines contribution metrics for the individual channels based on the measured changes in error. The two measures of change in error (that is, measures of change in the loss function) for the neural network (i) with the channel in place and (ii) without the channel in place both indicate an extent to which the channel influences the outcomes of the neural network. The extent that the channel influences outcomes of the neural network is a measure of importance of the neural network. The extent of channel influence on neural network output is thus a contribution metric that quantifies the importance of the channel. In one embodiment, the steps of block 225 may be performed by importance determiner 115.

In one embodiment, importance-based pruning method 200 determines a gradient-based importance (or gradient-based contribution metric) from a first-order change in the loss function due to removal of a channel, for example as shown and described with reference to Eq. 6 below. Importance-based pruning method stores the gradient-based importance in association with the channel, for example in the list of channels. And, in one embodiment, importance-based pruning method 200 determines an information-based importance (or information-based contribution metric) from a second-order change in the loss function due to removal of a channel, for example as shown and described with reference to Eq. 8 below. Importance-based pruning method also stores the information-based importance in association with the channel, for example in the list of channels. In one embodiment, importance-based pruning method 200 then combines the gradient-based importance for a channel and the information-based importance for the channel to produce an overall importance for the channel. For example, the gradient-based importance and information-based importance for a channel are summed to produce the overall importance (or overall contribution metric) for the channel. The overall importance determined for the channel may be stored in association with the channel, for example in the list of channels.

Including the second-order analysis ensures that at least some higher-order statistics about how the channel influences the outcomes of the neural network are not left out of the importance analysis. Inclusion of the higher-order statistics improves the accuracy of the overall level of importance for a given channel. More accurate importances for channels allows the neural network to be pruned based on the importance with less loss of accuracy. This allows higher compression of a trained neural network for the same cost in lost accuracy, an improvement over what can be provided by other pruning methods. And, this also allows the neural network to be pruned with reduced loss in output accuracy compared with other pruning methods, an improvement over what can be provided by other pruning methods. (This is validated experimentally as indicated under the “Experimental Validation” headings below).

In one embodiment, additional measures of importance may be derived from analyses of changes in the loss function at derivative orders above second-order and combined with the first-order and second-order importances, although the information contributed by analyses above second order derivatives of the loss function may be small.

At block 230, importance-based pruning method 200 reconfigures the neural network to remove a set of the individual channels that contribute least towards the accuracy of the estimate produced by the neural network. For example, the neural network is reconfigured by deleting the channels that are lowest in importance (indicated, for example, by having a lowest contribution metric). In other words, channels that contribute little to generation of outcomes by the neural network are pruned away from the neural network. In one embodiment, the set of low importance channels is identified, and then the low importance channels are deactivated. In one embodiment, the low importance channels are gathered and grouped together so that they can be pruned away one at a time until the neural network is sufficiently reduced in size and/or processing time. In one embodiment, the steps of block 230 may be performed by channel sorter 120 and network pruner 125.

At block 235, importance-based pruning method 200 ranks the channels by the respective importances (contribution metrics) of the channels. The least important channels are collected by ranking or sorting the channels by importance (contribution metric). In one embodiment, the ranking process is performed based on the channel list data structure. For example, the channel list data structure is accessed, and rearranged to place the channels in order of the overall importance of the channel. The channels may be sorted in one of ascending order or descending order of overall importance. As a result of the sorting, the channels are ranked by their respective importances. The channels having least importance are gathered together at a low end of the rankings. In one embodiment, the steps of block 235 may be performed by channel sorter 120.

At block 240, importance-based pruning method 200 prunes out of the convolutional neural network channels that are least ranked in importance (contribution metric) until a condition is satisfied. Thus, once the collection or set of low-importance channels is identified, the low importance channels are deleted, deactivated or otherwise removed from the neural network. In one embodiment, a channel is removed in a manner similar to that described above in process block 215. In summary, the parameters of the neural network that are associated with the channel are accessed and either (1) set to 0 or (2) deleted altogether in order to prune the channel out of the neural network. The channel (and the filter that produces the channel as output) is thereby removed from the neural network. Pruning channels that proceed from a filter eliminates the effects of that filter on the neural network. In one embodiment, the steps of block 240 may be performed by network pruner 125.

These pruning steps may be repeated to remove more than one channel that has low importance to the neural network (i.e., has a small influence on the accuracy of neural network outcomes). In one embodiment, multiple channels having low importance are removed in ascending order of contribution metric, starting with the channel of least importance (having the lowest contribution metric). Channels with low importance may be removed in ascending order of importance until a termination condition for concluding the pruning process (such as condition 160) is satisfied. In one embodiment, the termination condition specifies a condition of the neural network that may be brought about through the pruning process. In one embodiment, importance-based pruning method 200 evaluates the termination condition after each low-importance channel is removed to determine whether or not to remove a further low-importance channel. For example, where the termination condition is satisfied, pruning ceases. And, where the termination condition is not satisfied, pruning continues through another iteration and removes the channel having the next-lowest importance. In other words, the least important channel is pruned away in a loop that repeats until the termination condition is satisfied. In this way, the underperforming, low-importance channels are filtered out of the neural network.

As discussed above with reference to FIG. 1, the termination condition may be a pruning ratio (or compression ratio) that indicates how much the neural network has been reduced in size from its unpruned state. The termination condition may be a pre-specified number of channels permitted to the neural network. The termination condition may be a number of processor operations (such as FLOPs) taken to generate an output from inputs using the pruned neural network. In one embodiment, to evaluate a termination condition based on number of processor operations, a test execution of the pruned neural network is performed on one (or more) input vectors, and the number of processor operations counted for comparison against a threshold cap on operations.

In one embodiment, the termination condition is pre-specified, for example by a user. In one embodiment, the termination condition is entered by a user in response to a prompt to specify the termination condition or select the termination condition from a collection of pre-specified termination conditions. In one embodiment, the termination condition is associated with a particular resource-constrained device that is a target environment for operating the neural network. A termination condition associated with a resource-constrained device is configured to cause the neural network to be pruned so as to be operable within the compute resource limitations of the resource-constrained device. In one embodiment, the termination condition causes the neural network to be pruned so as to be operable to generate outputs from inputs in real time, without a backlog, within the within the compute resource limitations of the resource-constrained device. In one embodiment, the termination condition may be specified by data received from the resource-constrained device that specifies the compute resource limitations that the neural network is to conform to. The compute resource limitations may, for example, be expressed in terms of memory capacity or processor operations.

In one embodiment, a floor on accuracy of the pruned neural network may also be applied. Where the pruning causes the neural network to exhibit too little accuracy of output estimates and thus fall below a minimum accuracy threshold, (i) a warning may be presented in a user interface that prompts the user to enter an input that indicates whether or not the user wishes to proceed, or (ii) the pruning process may be halted and the pruned network indicated to be insufficiently accurate.

In one embodiment, importance-based pruning method 200 writes the pruned neural network to memory or storage for subsequent use or deployment. For example, the data structure of the neural network as pruned, with the parameters for the removed channels set to zero or deleted entirely, may be saved and closed. In one embodiment, importance-based pruning method 200 deploys the neural network as pruned to a computing device, such as to a resource-constrained device that the neural network has been pruned to fit. In one embodiment, importance-based pruning method 200 executes the pruned neural network to generate output estimates from inputs.

Once the neural network is reconfigured at the conclusion of block 230, importance-based pruning method 200 proceeds to end block 245, where importance-based pruning method 200 completes. At a high level, importance-based pruning method 200 improves the technology of neural network pruning by removing channels that are least important, that is, channels that contribute least to the accuracy of the outputs of the neural network. In one embodiment, the overall importance metric (or contribution metric) employed in importance-based pruning method 200 improves the technology of neural network pruning because the overall importance metric is more accurate, resulting in more accurate decisions about which channels to prune away, and which channels to retain. Therefore, neural networks may be reduced to smaller sizes while maintaining higher accuracy.

In one embodiment, importance-based pruning method 200 accesses a trained convolutional neural network that has a plurality of channels. The convolutional neural network is to be evaluated for pruning of the channels. Then, importance-based pruning method 200 determines contribution metrics for the channels by measuring changes in error of the convolutional neural network with individual channels removed in turn. The contribution metrics are determined based at least in part on higher order analysis of the changes. Importance-based pruning method 200 then prunes out of the convolutional neural network a set of the channels for which the contribution metrics do not satisfy a threshold.

In one embodiment, importance-based pruning method 200 accesses a trained convolutional neural network that has a plurality of channels. The convolutional neural network is to be evaluated for pruning of the channels. Importance-based pruning method 200 determines contribution metrics for the channels by measuring changes in error of the convolutional neural network with individual channels removed in turn. Importance-based pruning method 200 then ranks the channels by the respective contribution metrics of the channels. Importance-based pruning method 200 then prunes out of the convolutional neural network channels that are least ranked in importance (contribution metric) until a condition is satisfied.

In one embodiment, importance-based pruning method 200 accesses a neural network that has been trained to generate an estimate based on a plurality of channels. Importance-based pruning method 200 measures changes in error of the estimate due to removal of individual channels of the plurality of channels from the neural network. Based on the measured changes in error, importance-based pruning method 200 then determines extents of contribution towards the accuracy of the estimate for the individual channels. Importance-based pruning method 200 then reconfigures the neural network to remove a set of the individual channels that contribute least towards the accuracy of the estimate.

### —Further Embodiments of Importance-Based Pruning Method—

In one embodiment, determining the contribution metrics or importances for the channels (as discussed above at block 215) further includes steps to determine both gradient-based and information-based contribution metrics for individual channels, and combine the two metrics to produce an overall contribution metric for the individual channels. The steps of determining and combining the gradient-based and information-based contribution metrics determines contribution metrics for the channels by measuring changes in error of the neural network with individual channels removed in turn.

In one embodiment, importance-based pruning method 200 determines a gradient-based contribution metric of one of the channels (for example as discussed below at block 315). In one embodiment, importance-based pruning method 200 determines a gradient-based contribution metric of one of the channels by approximating a loss (or cost) function using a combination of (a) an approximation matrix based on a scaling parameter and (b) a shifting parameter. In one embodiment, the approximation matrix is a Jacobian matrix (that is, the matrix of first-order partial derivatives) of a cost function used for training the neural network. Thus, in one embodiment, measuring changes in error of the estimate due to removal of individual channels of the plurality of channels from the neural network (as discussed above at block 220) includes determining a first order approximation of a change in a loss function used in training of the neural network when an individual channel is removed from the neural network.

Then, importance-based pruning method 200 determines an information-based contribution metric of the one of the channels (for example as described below at block 320). In one embodiment, importance-based pruning method 200 determines an information-based contribution metric of one of the channels by using a higher-order approximation of a fluctuation of a loss function. In one embodiment, the higher-order approximation of the fluctuation (or change) in the loss function is based on Fisher information. For example, the Fisher information is a Fisher information matrix that is used to approximate a Hessian matrix (that is, a square matrix of second-order partial derivatives) of the cost function used for training the neural network. Thus, in one embodiment, measuring changes in error of the estimate due to removal of individual channels of the plurality of channels from the neural network (as discussed above at block 220) includes determining a higher order approximation of the change in the loss function when the individual channel is removed from the neural network.

Then, importance-based pruning method 200 combines the gradient-based contribution metric and the information-based contribution metric to produce the overall contribution metric for the one of the channels (for example as described below at block 325). Determine extents of contribution towards the accuracy of the estimate for the individual channels based on the measured changes in error (as discussed above at block 225) therefore includes combining the first order approximation and higher order approximation to quantify an extent of contribution of the individual channel towards the accuracy of the estimate. These steps may be repeated to determine the importances (contribution metrics) of more than one channel in the neural network, up to and including all channels in the neural network.

In one embodiment, pruning out of the convolutional neural network a set of the channels for which the importances or contribution metrics do not satisfy a threshold (as discussed above at block 240) includes steps to delete or otherwise remove channels that do not satisfy a threshold. In one embodiment, the threshold is set based on either (a) a target channel pruning ratio (compression ratio) or (b) a resource constraint. Thus, in one embodiment, importance-based pruning method 200 iteratively removes a channel with a lowest overall contribution metric (or importance) from among the channels remaining in the convolutional neural network until either (a) a target channel pruning ratio is reached or (b) a resource constraint is satisfied. Thus, reconfiguring the trained convolutional neural network to remove a set of the individual channels that contribute least towards the accuracy of the estimate (as discussed above at block 230) may further include iteratively removing a channel with a lowest extent of contribution until either (a) a target compression ratio is reached or (b) a resource constraint is satisfied. In one embodiment, the target channel pruning ratio is a pre-specified ratio of the number of channels in the pruned neural network to the number of channels in the unpruned network. In one embodiment, the resource constraint is a cap on processor operations (such as FLOPs) used by the neural network to infer an output from the inputs. In one embodiment, the resource constraint is a maximum size of the neural network in memory.

In one embodiment, importance-based pruning method 200 further includes steps to use the pruned neural network to infer outcomes from inputs. In one embodiment, importance-based pruning method 200 executes the convolutional neural network in a pruned state to generate estimates using fewer compute resources than the convolutional neural network in an unpruned state. In other words, the neural network infers the estimated outcomes using fewer compute resources (e.g., memory, processor operations) in the pruned state when compared with the compute resources consumed by the neural network in the unpruned state to infer the estimated outcomes. In one embodiment, the importance-based pruning method 200 further executes the convolutional neural network in a pruned state to generate estimates at an increased compute speed over the convolutional neural network in an unpruned state.

In one embodiment, importance-based pruning method 200 further includes steps to move the pruned neural network to devices which the neural network has been pruned to fit. Thus, in one embodiment, importance-based pruning method 200 deploys the convolutional neural network in a pruned state to a resource-constrained device. For example, the importance-based pruning method transmits the reconfigured neural network to the resource-constrained device along with instructions executable by the resource constrained device to install and operate the pruned neural network. Then, importance-based pruning method 200 executes the reconfigured neural network (e.g. pruned convolutional neural network in the pruned state) using the resource constrained device. Thus, in one embodiment, the resource-constrained device may then use the pruned neural network to infer outcomes from inputs locally, within (that is, without exceeding or overwhelming) the available compute resources of the resource-constrained device.

In one embodiment, the neural network is a convolutional neural network (CNN). In one embodiment, the neural network is a deep neural network (DNN).

### Additional Embodiments

Neural network models (such as DNN and CNN models) have greatly increased performance for many computer vision tasks such as image classification, image segmentation, objection detection, human pose detection, and so on. However, for mobile and edge devices that are limited in computing resources, the large size and computational burden of neural network models presents substantial obstacles. For example, a VGG-16 model (an example CNN model architecture) is about 150 Mb and uses about 15 billion floating point operations (FLOPs) to classify one color image of 224×224 pixels. Network pruning provides compression of the neural network in order to mitigate the size and computational burden of the neural networks.

In one embodiment, the importance-based pruning systems and methods described herein introduce a novel neural network pruning method based on the importance (contribution metric) of channels in the neural network to effectively reduce the computational burden of the neural network models. In one embodiment, the importance-based pruning system employs a new and effective metric that evaluates the importance of channels in a neural network based on batch normalization parameters and 2nd order Fisher information measurement. Specifically, in one embodiment, gradient information during back propagation is fully utilized by considering characteristics of neural network architecture with batch normalization (BN) and rectified linear unit (ReLU) layers. In addition, 2nd order Taylor expansion of the loss fluctuation is also integrated. In this way a highly-accurate assessment of the importance of a channel to a neural network model can be effectively identified. As discussed below under the heading “Experimental Validation of Improvements”, tests on benchmark datasets show improved performance of neural network model compression where importance-based pruning as described herein is implemented.

### —Preliminary Matters—

FIG. 3 illustrates one embodiment of an importance-based pruning method 300 associated with pruning of neural network models. Importance-based pruning method 300 commences at start block 305 and proceeds to block 310. At block 310, importance-based pruning method 300 accesses a convolutional neural network for pruning. In one embodiment, the convolutional neural network is accessed as described above at block 210. For context, various characteristics of the convolutional neural network are described herein.

Convolutional neural networks (such as deep CNNs) may have repetitive design patterns that consist of a batch normalization (BN) layer followed by a rectified linear (ReLU) activation layer. The BN layer operates to boost the network training speed and facilitate stable training process. The BN layer accomplishes these functions based on reducing the feature distribution in each layer from internal covariate shift. Given the input xⁱⁿ of a BN layer, the output x^{out} can be calculated as shown in Eq. 1 and Eq. 2:

$$z = \frac{{x}^{in} - \hat{μ}}{\sqrt{{\hat{σ}}^{2} + ϵ}} \qquad Eq . 1$$

$${x}^{out} = γ * z + β \qquad Eq . 2$$

where ∈ is a small positive value to prevent division by zero for numerical stability; γ and β are learnable affine parameters for scaling and shifting, respectively, the output of the BN layer; \hat{μ} is the mean of the activations (\hat{μ}=E(xⁱⁿ)); and \hat{σ}² is the variance of the activations (\hat{σ}²=Var(xⁱⁿ)).

For a CNN model that contains the weight matrix Θ trained on a dataset D, it may be assumed that that the CNN model has L layers. A goal of the importance-based pruning method 300 is to remove redundant feature maps or parameters that contribute little to the performance of the CNN model. The output of each layer can be represented by F^{l}∈H^{l}*W^{l}*C^{l}, where C^{l} means the channel dimension and l∈{1, 2, . . . . L}. For a convolutional layer, it may be assumed that the weight tensor of the convolutional layer is W^{l} with a bias tensor term of b^{l}. The subsequent (following) BN layer also has two affine parameters for scaling and shifting, that is, γ^{l} and β^{l}, respectively.

### —Gradient-Based Importance (First Order)—

At block 315, importance-based pruning method 300 determines a gradient-based importance (or gradient-based contribution metric) of one of the channels of the convolutional neural network. To obtain an importance of a channel, the error fluctuation may be measured when a channel-wise filter Fⱼ^{l} in a pretrained model is pruned. To approximate such a change where one channel is removed, the influence can be reflected by Eq. 3:

$$C ( D \vert θ ( {F}_{j}^{l} = 0 ) ) - C ( D \vert θ ) \qquad Eq . 3$$

where C is the cost function used for training. With Taylor expansion, the loss function can be expanded at point of Fⱼ^{l}=0, as shown in Eq. 4:

$$C ( D \vert θ ( {F}_{j}^{l} = 0 ) ) = C ( D \vert θ ) - \frac{δ C}{δ {F}_{j}^{l}} {F}_{j}^{l} + {R}_{1} ( {F}_{j}^{l} = 0 ) \qquad Eq . 4$$

where R₁ denotes the higher order Lagrange reminder. The loss function can be further represented with a Jacobian matrix as shown in Eq. 5:

$$J ( {F}_{j}^{l} ) = \frac{δ C}{δ {F}_{j}^{l}} \qquad Eq . 5$$

By applying some derivations, it can be demonstrated that for a CNN with BN-ReLU module, the gradient-based importance of a channel l₁(Fⱼ^{l}) can be measured with a combination of the scaling parameter and shifting parameter as shown in Eq. 6:

$${I}_{1} ( {F}_{j}^{l} ) = \vert J ( {γ}_{j}^{l} ) {γ}_{j}^{l} \vert + {λβ}_{j}^{l} \qquad Eq . 6$$

### —Fisher Information-Based Importance—

At block 320, importance-based pruning method 300 determines an information-based importance (or information-based contribution metric) of the one of the channels. The gradient-based channel importance discussed above mainly makes use of 1st order Taylor expansion. In the gradient-based channel importance, the higher order terms are directly ignored. However, higher order statistics about the weight or activation may still contain some discriminative information about the feature that is of benefit to object classification or detection. Therefore, at process block 320, 2nd order Taylor expansion is further performed to explore more features.

The change or fluctuation of the loss can be approximated by Eq. 7, as follows:

$$C ( D \vert θ ( {F}_{j}^{l} = 0 ) ) - C ( D \vert θ ) \approx - \frac{δ C}{δ {F}_{j}^{l}} {F}_{j}^{l} + \frac{1}{2} {H}_{jj} {F}_{j}^{{l}^{2}} \qquad Eq . 7$$

where Hⱼⱼ is the corresponding Hessian matrix at Fⱼ^{l}=0.

The Hessian can be further approximated with the Fisher information matrix. And then, if N data points are applied to estimate the Fisher information, the approximation of the fluctuation in the loss function becomes, as shown in Eq. 8:

$${I}_{2} ( {F}_{j}^{l} ) = \frac{1}{2} {( {F}_{j}^{l} )}^{2} {\sum }_{n = 1}^{n = N} {g}_{nj}^{2} \qquad Eq . 8$$

where gₙⱼ is the gradient of the parameters with respect to the nth data point. Thus, in one embodiment, the information-based importance I₂(Fⱼ^{l}) of a given channel l may be found.

### —Comprehensive Channel Importance Sorting and Pruning—

At block 325, importance-based pruning method 300 combines the gradient-based importance and the information-based importance to produce an overall importance for the one of the channels. With the channel importance measured using both gradient (in process block 315) and Fisher information in (process block 320), these two measures of importance may be combined to produce an overall importance. In one embodiment, the gradient-based importance I₁(Fⱼ^{l}) and the information-based importance I₂(Fⱼ^{l}) are combined by summing or addition of the two importances to produce the overall importance. The overall importance is a more accurate measure of importance for a given channel than gradient-based importance alone. The overall importance may be used to prune an over parameterized CNN and reduce the memory footprint or the computational burden of the model.

In one embodiment, channels are pruned from a neural network (such as a deep convolutional neural network (DCNN)) using the overall importance metric (that is, the combined gradient-based importance and information-based importance). Starting from a pre-trained neural network, a mini-batch of data is randomly sampled from the training set. The sampled mini-batch of data is fed into the neural network. In one embodiment, the mini-batch of data is a subset of the data that was used to train the neural network into its current trained state. Note that utilizing a batch or subset of the training data is more effective for identifying channel saliencies than using the whole training set. In one embodiment, the mini-batch of data is a selection of fewer than 10%, or fewer than 1% of the training vectors available in the training set. For example, a mini-batch of 128 images randomly sampled from the CIFAR10 dataset of 60,000 labeled images is sufficient, in one embodiment, to identify the gradient-based and information-based importances of channels as described herein. In one embodiment, a mini-batch of data having fewer than 0.01% of the available training vectors may be sufficient, such as a mini-batch of 128 images randomly sampled from the ImageNet 2012 dataset of approximately 1.2 million labeled images.

With one forward-back propagation, the gradients (represented by Jacobian matrixes of the scaling functions J(γⱼ^{l})) in normalization layers are computed and saved following the chain rule. The parameters of the neural network generated during the forward-back propagation are recorded or stored. Specially, the parameters of the neural network are not updated during importance evaluation to avoid network status fluctuation. To jointly consider the channels in different layers and prune the model globally, layer-wise l₂ normalization is performed on the Jacobian matrixes of the scaling parameters J(γⱼ^{l}), the scaling parameters γⱼ^{l}, the shifting parameters βⱼ^{l}, and the information-based importance I₂(Fⱼ^{l}) to restrict their ranges to between [−1, 1].

At block 325, importance-based pruning method 300 combines the gradient-based importance of process block 315 and the information-based importance of process block 320 to produce the measure of importance for the one of the channels. In one embodiment, generation of the gradient-based and information-based importance and combination of these importances to produce the overall importance is repeated for each of the channels. For example, the overall importance of each channel is generated by combining Eqs. 6 and 8.

At process block 330, importance-based pruning method 300 sorts the channels by the importance of the channels. In particular, the channels of the neural network are ranked or sorted by overall importance (such as is shown above at process block 235). For example, the channels of the neural network are sorted in ascending order of overall importance.

At process block 335, importance-based pruning method 300 deletes or otherwise removes the channels with the lowest overall importance until a condition is satisfied. For example, the channels with the lowest values are deleted until the desired channel pruning ratio or resource constraint is achieved. In one embodiment, the condition may be a pre-specified value for a pruning ratio. In one embodiment, the pruning ratio is a ratio between the number of channels in the unpruned neural network and the number of channels in the pruned neural network. In one embodiment, the pruning ratio is the FLOPs pruning ratio discussed below. And, in one embodiment the condition may be a resource constraint. The resource constraint may be a size in memory for the pruned neural network. Or, the resource constraint may be an amount of processing time for the neural network to produce an output (such as an image classification or object detection). For example, the resource constraint may be a maximum number of or cap on floating point operations (FLOPs) performed by the inference process of the neural network.

### —Experimental Validation of Improvements—

In one example application, results on one typical computer vision task of image classification is performed to validate the performance of importance-based pruning as described herein. The hyperparameter λ is chosen as 0.05. In the validation examples, importance-based pruning as shown and described herein improves the performance of neural networks to a greater extent than other network pruning methods.

### —Experimental Validation—Image Classification on CIFAR10—

The CIFAR10 dataset is a common dataset including 60,000 images for ten classes each of which has 6,000 images. The CIFAR10 dataset has been tested for image classification tasks using various network pruning methods. Methods such as filter pruning via geometric median (FPGM), channel pruning (CP), soft filtering pruning (SFP), automated deep compression (AMC), High Rank of feature maps (HRank), Discrete Model Compression (DMC), were compared with importance-based pruning (IBP) in experimental tests. In the experimental tests, various pruning methods are applied to different neural network models, such as ResNet20, ResNet32, and ResNet56, that are trained using the CIFAR10 dataset.

The comparison results are shown in Table 1. The pruning results are expressed in Table 1 in terms of accuracy, accuracy drop (AD) and FLOPs pruning ratio (FPR). For FPR, higher values mean lower computation loads. The best performances are highlighted in bold.

TABLE 1
Comparisons of Various Pruning Methods on CIFAR10

| Model | Method | Accuracy | AD | FPR |
|---|---|---|---|---|
| ResNet20 | SFP | 90.83% | 1.37% | 40.00% |
| ResNet20 | FPGM | 91.09% | 1.11% | 40.00% |
| ResNet20 | DSA | 91.54% | 0.66% | 50.00% |
| ResNet20 | IBP | 91.97% | 0.23% | 53.00% |
| ResNet32 | SFP | 92.08% | 0.59% | 41.50% |
| ResNet32 | FPGM | 92.35% | 0.32% | 41.50% |
| ResNet32 | IBP | 92.68% | −0.01% | 42.00% |
| ResNet56 | CP | 91.80% | 1.00% | 50.00% |
| ResNet56 | AMC | 91.90% | 0.90% | 50.00% |
| ResNet56 | SFP | 92.56% | 0.24% | 52.60% |
| ResNet56 | FPGM | 92.70% | 0.10% | 52.60% |
| ResNet56 | HRank | 92.71% | 0.09% | 50.00% |
| ResNet56 | DMC | 92.87% | −0.07% | 50.00% |
| ResNet56 | IBP | 93.04% | −0.24% | 52.00% |

Accuracy drop (AD) may be considered an objective performance measurement to evaluate different model pruning algorithms. For ResNet20, importance-based pruning as described herein can achieve both a much larger FPR of 53% than other pruning methods and much lower AD of 0.23% than other pruning methods. While for ResNet32, when the FPR is comparable at the ratio of 42%, our importance-based pruning as described herein obtains an AD of −0.01% (slight increase in accuracy). On another typical model of ResNet56, importance-based pruning as described herein also shows much the lowest AD of −0.24% (increase in accuracy) with comparable FPR of 52%. Such results validate that the importance-based pruning as described herein is better at pruning CNN models while keeping the accuracy of original CNN models.

### —Experimental Validation—Image Classification on ImageNet-2012—

To further illustrate the efficacy of importance-based pruning as described herein, importance-based pruning is also tested on the ImageNet 2012 dataset using ResNet34 and ResNet50 models. The ImageNet 2012 dataset is another dataset that contains about 1.2 million images. The ImageNet 2012 dataset has also been tested for image classification tasks. In the experimental tests, various pruning methods are applied to the different neural network models that were trained on the ImageNet 2012 dataset. The results are recorded in Table 2. From Table 2, it can be observed that on ImageNet dataset, importance-based pruning can also obtain better FPR with less AD at the same time on two CNN models of ResNet34 and ResNet50.

TABLE 2
Comparisons of Various Pruning methods on ImageNet-2012

| Model | Method | Accuracy | AD | FPR |
|---|---|---|---|---|
| ResNet34 | SFP | 71.83% | 1.44% | 41.10% |
| ResNet34 | FPGM | 72.11% | 1.16% | 41.10% |
| ResNet34 | IBP | 72.95% | 0.32% | 42.00% |
| ResNet50 | SFP | 74.61% | 1.38% | 41.80% |
| ResNet50 | FPGM | 75.50% | 0.45% | 42.20% |
| ResNet50 | HRANK | 74.98% | 1.01% | 43.70% |
| ResNet50 | IBP | 76.15% | −0.16% | 45.00% |

### —Cloud or Enterprise Embodiments—

In one embodiment, the present system (such as importance-based pruning system 100) is a computing/data processing system including a computing application or collection of distributed computing applications for access and use by other client computing devices that communicate with the present system over a network. In one embodiment, importance-based pruning system 100 is a component of a time series data service that is configured to gather, serve, and execute operations on time series data. The applications and computing system may be configured to operate with or be implemented as a cloud-based network computing system, an infrastructure-as-a-service (IAAS), platform-as-a-service (PAAS), or software-as-a-service (SAAS) architecture, or other type of networked computing solution. In one embodiment the present system provides at least one or more of the functions disclosed herein and a graphical user interface to access and operate the functions. In one embodiment, importance-based pruning system 100 is a centralized server-side application that provides at least the functions disclosed herein and that is accessed by many users by way of computing devices/terminals communicating with the computers of importance-based pruning system 100 (functioning as one or more servers) over a computer network. In one embodiment importance-based pruning system 100 may be implemented by a server or other computing device configured with hardware and software to implement the functions and features described herein.

In one embodiment, the components of importance-based pruning system 100 may be implemented as sets of one or more software modules executed by one or more computing devices specially configured for such execution. In one embodiment, the components of importance-based pruning system 100 are implemented on one or more hardware computing devices or hosts interconnected by a data network. For example, the components of importance-based pruning system 100 may be executed by network-connected computing devices of one or more compute hardware shapes, such as central processing unit (CPU) or general-purpose shapes, dense input/output (I/O) shapes, graphics processing unit (GPU) shapes, and high-performance computing (HPC) shapes.

In one embodiment, the components of importance-based pruning system 100 intercommunicate by electronic messages or signals. These electronic messages or signals may be configured as calls to functions or procedures that access the features or data of the component, such as for example application programming interface (API) calls. In one embodiment, these electronic messages or signals are sent between hosts in a format compatible with transmission control protocol/internet protocol (TCP/IP) or other computer networking protocol. Components of importance-based pruning system 100 may (i) generate or compose an electronic message or signal to issue a command or request to another component, (ii) transmit the message or signal to other components of importance-based pruning system 100, (iii) parse the content of an electronic message or signal received to identify commands or requests that the component can perform, and (iv) in response to identifying the command or request, automatically perform or execute the command or request. The electronic messages or signals may include queries against databases. The queries may be composed and executed in query languages compatible with the database and executed in a runtime environment compatible with the query language.

In one embodiment, remote computing systems may access information or applications provided by importance-based pruning system 100, for example through a web interface server. In one embodiment, the remote computing system may send requests to and receive responses from importance-based pruning system 100. In one example, access to the information or applications may be effected through use of a web browser on a personal computer or mobile device. In one example, communications exchanged with importance-based pruning system 100 may take the form of remote representational state transfer (REST) requests using JavaScript object notation (JSON) as the data interchange format for example, or simple object access protocol (SOAP) requests to and from XML servers. The REST or SOAP requests may include API calls to components of importance-based pruning system 100.

### —Software Module Embodiments—

In general, software instructions are designed to be executed by one or more suitably programmed processors accessing memory. Software instructions may include, for example, computer-executable code and source code that may be compiled into computer-executable code. These software instructions may also include instructions written in an interpreted programming language, such as a scripting language.

In a complex system, such instructions may be arranged into program modules with each such module performing a specific task, process, function, or operation. The entire set of modules may be controlled or coordinated in their operation by an operating system (OS) or other form of organizational platform.

In one embodiment, one or more of the components described herein are configured as modules stored in a non-transitory computer readable medium. The modules are configured with stored software instructions that when executed by at least a processor accessing memory or storage cause the computing device to perform the corresponding function(s) as described herein.

### —Computing Device Embodiment—

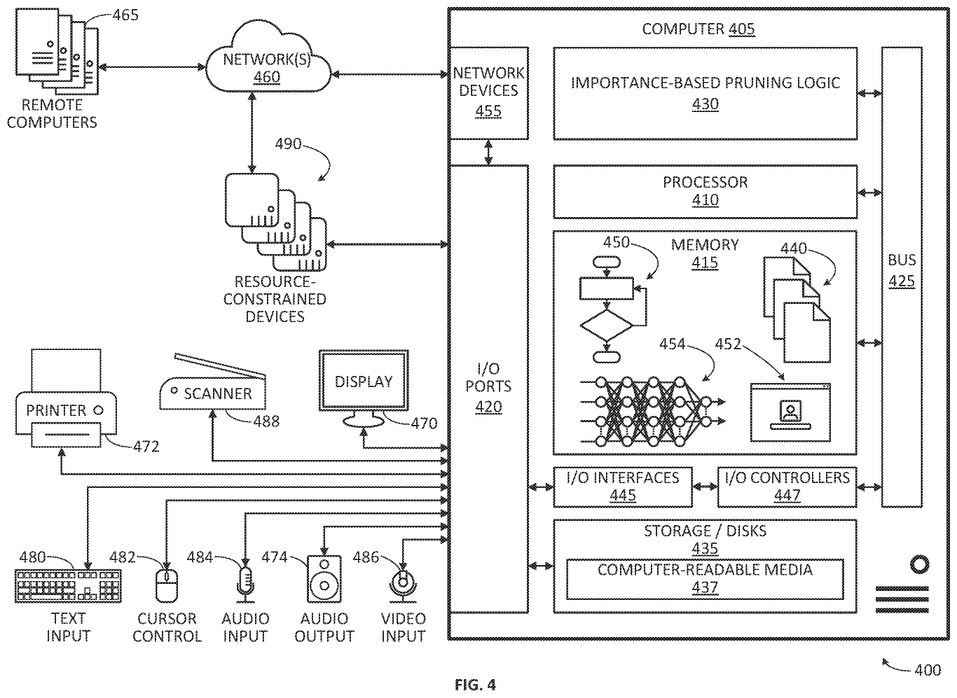

FIG. 4 illustrates an example computing system 400 that is configured and/or programmed as a special purpose computing device with one or more of the example systems and methods described herein, and/or equivalents. The example computing system 400 may include a computer 405 that includes at least one hardware processor 410, a memory 415, and input/output ports 420 operably connected by a bus 425. In one example, the computer 405 may include importance-based pruning logic 430 configured to facilitate pruning of channels in neural network models similar to importance-based pruning system 100, importance-based pruning methods 200 and 300, or other embodiments, as shown and described herein with reference to FIGS. 1-3.

In different examples, the logic 430 may be implemented in hardware, a non-transitory computer-readable medium 437 with stored instructions, firmware, and/or combinations thereof. While the logic 430 is illustrated as a hardware component attached to the bus 425, it is to be appreciated that in other embodiments, the logic 430 could be implemented in the processor 410, stored in memory 415, or stored in disk 435.

In one embodiment, logic 430 or the computer is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an ASIC programmed to facilitate pruning of channels in neural network models similar to importance-based pruning system 100, importance-based pruning methods 200 and 300, or other embodiments, as shown and described herein. The means may also be implemented as stored computer executable instructions that are presented to computer 405 as data 440 that are temporarily stored in memory 415 and then executed by processor 410.

Logic 430 may also provide means (e.g., hardware, non-transitory computer-readable medium that stores executable instructions, firmware) for performing one or more of the disclosed functions and/or combinations of the functions.

Generally describing an example configuration of the computer 405, the processor 410 may be a variety of various processors including dual microprocessor and other multi-processor architectures. A memory 415 may include volatile memory and/or non-volatile memory. Non-volatile memory may include, for example, read-only memory (ROM), programmable ROM (PROM), and so on. Volatile memory may include, for example, random access memory (RAM), static RAM (SRAM), dynamic RAM (DRAM), and so on.

A storage disk 435 may be operably connected to the computer 405 via, for example, an input/output (I/O) interface (e.g., card, device) 445 and an input/output port 420 that are controlled by at least an input/output (I/O) controller 447. The disk 435 may be, for example, a magnetic disk drive, a solid-state disk drive, a floppy disk drive, a tape drive, a Zip drive, a flash memory card, a memory stick, and so on. Furthermore, the disk 435 may be a CD-ROM drive, a CD-R drive, a CD-RW drive, a DVD ROM, and so on. The disk 435 and memory 415 can store a process 450 and/or a data 440, for example. The disk 435 and/or the memory 415 can store an operating system 452 that controls and allocates resources of the computer 405. In one embodiment, the disk 435 and/or the memory 415 can store a neural network 454, for example while neural network 454 is being pruned as described herein.

The computer 405 may interact with, control, and/or be controlled by input/output (I/O) devices via the input/output (I/O) controller 447, the I/O interfaces 445, and the input/output ports 420. Input/output devices may include, for example, one or more displays 470, printers 472 (such as inkjet, laser, or 3D printers), audio output devices 474 (such as speakers or headphones), text input devices 480 (such as keyboards), cursor control devices 482 for pointing and selection inputs (such as mice, trackballs, touch screens, joysticks, pointing sticks, electronic styluses, electronic pen tablets), audio input devices 484 (such as microphones or external audio players), video input devices 486 (such as video and still cameras, or external video players), image scanners 488, video cards (not shown), disks 435, network devices 455, and so on. The input/output ports 420 may include, for example, serial ports, parallel ports, and USB ports.

The computer 405 can operate in a network environment and thus may be connected to the network devices 455 via the I/O interfaces 445, and/or the I/O ports 420. Through the network devices 455, the computer 405 may interact with a network 460. Through the network, the computer 405 may be logically connected to remote computers 465. Networks with which the computer 405 may interact include, but are not limited to, a LAN, a WAN, and other networks.

In one embodiment, the computer 405 may be connected, at least temporarily, to one or more resource-constrained devices 490 through networks 460 and/or I/O ports 420. Configuration information describing limitations on the compute resources (such as memory or processor speed) of resource constrained devices 490 may be requested by computer 405, for example from resource constrained devices 490, and transmitted to computer 405 by resource-constrained devices 490. Computer 405 may prune neural network 454 in accordance with the importance-based pruning logic 430 to satisfy the limitations of resource constrained devices 490. And, computer 405 may deploy the pruned neural network to one or more resource-constrained devices 490. Resource-constrained devices 490 may then execute the pruned neural network locally to infer outcomes from inputs of the resource-constrained devices. In one embodiment, one or more resource-constrained devices 490 has an architecture similar to that of computer 405. In one embodiment, computer 405 is itself a resource-constrained device.

### Definitions and Other Embodiments

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks. The methods described herein are limited to statutory subject matter under 35 U.S.C. § 101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium”, as used herein, refers to a non-transitory medium that stores instructions and/or data configured to perform one or more of the disclosed functions when executed. Data may function as instructions in some embodiments. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C. § 101.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions. Logic is limited to statutory subject matter under 35 U.S.C. § 101.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). Logical and/or physical communication channels can be used to create an operable connection.

“User”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. § 101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

What is claimed is:

1. One or more non-transitory computer-readable media that includes stored thereon computer-executable instructions that when executed by at least a processor of a computing system cause the computing system to:
access a trained convolutional neural network that has a plurality of channels;
determine contribution metrics for the channels by measuring changes in error of the convolutional neural network with individual channels removed in turn, wherein the contribution metrics are determined based at least in part on higher order analysis of the changes; and
prune out of the convolutional neural network a set of the channels for which the contribution metrics do not satisfy a threshold.

2. The non-transitory computer-readable media of claim 1, wherein the instructions to determine the contribution metrics for the channels, when executed by at least the processor, cause the computing system to:
determine a gradient-based contribution metric of one of the channels;
determine an information-based contribution metric of the one of the channels; and
combine the gradient-based contribution metric and the information-based contribution metric to produce the contribution metric for the one of the channels.

3. The non-transitory computer-readable media of claim 1, wherein the instructions to determine the contribution metrics for the channels, when executed by at least the processor, cause the computing system to determine a gradient-based contribution metric of one of the channels by approximating a loss function using a combination of (a) an approximation matrix based on a scaling parameter and (b) a shifting parameter.

4. The non-transitory computer-readable media of claim 1, wherein the instructions to determine the contribution metrics for the channels, when executed by at least the processor, cause the computing system to determine an information-based contribution metric of one of the channels by using a higher-order approximation of a fluctuation of a loss function.

5. The non-transitory computer-readable media of claim 1, wherein the instructions to prune out of the convolutional neural network a set of the channels for which the contribution metrics do not satisfy a threshold, when executed by at least the processor, further cause the computing system to iteratively remove a channel with a lowest contribution metric from among the channels remaining in the convolutional neural network until either (a) a target channel pruning ratio is reached or (b) a resource constraint is satisfied.

6. The non-transitory computer-readable media of claim 1, further comprising instructions that when executed by at least the processor cause the computing system to further execute the convolutional neural network in a pruned state to generate estimates.

7. A computer-implemented method, comprising:
accessing a trained convolutional neural network that has a plurality of channels, wherein the convolutional neural network is to be evaluated for pruning of the channels;
determining contribution metrics for the channels by measuring changes in error of the convolutional neural network with individual channels removed in turn;
ranking the channels by the respective contribution metrics of the channels; and
pruning out of the convolutional neural network channels that are least ranked in contribution metric until a condition is satisfied.

8. The computer-implemented method of claim 7, wherein determining the contribution metrics for the channels further comprises:
determining a gradient-based contribution metric of one of the channels;
determining an information-based contribution metric of the one of the channels; and
combining the gradient-based contribution metric and the information-based contribution metric to produce the contribution metric for the one of the channels.

9. The computer-implemented method of claim 7, wherein determining the contribution metrics for the channels further comprises determining a gradient-based contribution metric of one of the channels by approximating a loss function using a combination of (a) an approximation matrix based on a scaling parameter and (b) a shifting parameter.

10. The computer-implemented method of claim 9, wherein the approximation matrix is a Jacobian Matrix.

11. The computer-implemented method of claim 7, wherein determining the contribution metrics for the channels further comprises determining an information-based contribution metric of one of the channels by using a higher-order approximation of a fluctuation of a loss function.

12. The computer-implemented method of claim 11, wherein the higher-order approximation of the fluctuation is based on Fisher information.

13. The computer-implemented method of claim 7, wherein the threshold is set based on either (a) a target channel pruning ratio or (b) a resource constraint.

14. The computer-implemented method of claim 7, further comprising executing the convolutional neural network in a pruned state to generate estimates at an increased compute speed over the convolutional neural network in an unpruned state.

15. The computer-implemented method of claim 7, further comprising:
deploying the convolutional neural network in a pruned state to a resource-constrained device; and
executing the convolutional neural network in the pruned state using the resource constrained device.

16. A computing system, comprising:
at least one processor connected to at least one memory;
at least one non-transitory computer readable medium including instructions stored thereon that when executed by at least the processor cause the computing system to:
access a neural network that has been trained to generate an estimate based on a plurality of channels;
measure changes in error of the estimate due to removal of individual channels of the plurality of channels from the neural network;
determine extents of contribution towards the accuracy of the estimate for the individual channels based on the measured changes in error; and
reconfigure the neural network to remove a set of the individual channels that contribute least towards the accuracy of the estimate.

17. The computing system of claim 16,
wherein the instructions to measure changes in error of the estimate due to removal of individual channels of the plurality of channels from the neural network, when executed by at least the processor, cause the computing system to:
determine a first order approximation of a change in a loss function used in training of the neural network when an individual channel is removed from the neural network, and
determine a higher order approximation of the change in the loss function when the individual channel is removed from the neural network; and
wherein the instructions to determine extents of contribution towards the accuracy of the estimate for the individual channels based on the measured changes in error, when executed by at least the processor, cause the computing system to:
combine the first order approximation and higher order approximation to quantify an extent of contribution of the individual channel towards the accuracy of the estimate.

18. The computing system of claim 16, wherein the instructions to reconfigure the trained convolutional neural network to remove a set of the individual channels that contribute least towards the accuracy of the estimate, when executed by at least the processor, cause the computing system to iteratively remove a channel with a lowest extent of contribution until either (a) a target compression ratio is reached or (b) a resource constraint is satisfied.

19. The computing system of claim 16, wherein the system further comprises a resource-constrained device, and wherein the instructions when executed by at least the processor further cause the computing system to:
transmit the reconfigured neural network to the resource-constrained device; and
execute the reconfigured neural network using the resource-constrained device.

20. The computing system of claim 16, wherein the neural network is a convolutional neural network.
